(19) United States
(12) Patent Application Publication
(10) Pub. No.: US 2022/0032870 A1
(43) Pub. Date: Feb. 3, 2022

(54) MULTIPLE AIRBAG CONFIGURATION WITH REACTION SURFACE AIRBAG

(71) Applicant: Rivian IP Holdings, LLC, Plymouth, MI (US)

(72) Inventors: Gary Andrew Card, Macomb, MI (US); Jared Andrew Odle, Westland, MI (US)

(21) Appl. No.: 16/944,218

(22) Filed: Jul. 31, 2020

(51) Int. Cl. B60R 21/205; B60R 21/203; B60R 21/231

(52) U.S. Cl. CPC B60R 21/205; B60R 21/203; B60R 2021/0004; B60R 2021/23107; B60R 21/231

(57) ABSTRACT

Disclosed embodiments include apparatuses, systems, and methods for supportably deploying an occupant restraint airbag. In an illustrative embodiment, an apparatus includes an occupant restraint airbag configured to be deployable between an occupant of a vehicle and a forward structure of a vehicle interior. The occupant restraint airbag presents an occupant surface to engage at least a portion of a body of the occupant and a back surface on an opposing side of the occupant restraint airbag responsive to inflation thereof. A reaction surface airbag is deployable between the occupant restraint airbag and an interior surface of the vehicle. The reaction surface airbag presents a first surface configured to engage the back surface of the occupant restraint airbag and a second surface to engage the interior surface responsive to inflation of the reaction surface airbag. The reaction surface airbag resists movement of the occupant restraint airbag toward the interior surface.

The present disclosure relates to apparatuses, systems, and methods for supportably deploying an occupant restraint airbag in a vehicle.

The statements in this section merely provide background information related to the present disclosure and may not constitute prior art.

The inclusion and deployment of airbags or other supplemental restraint systems in vehicles may help contribute to preventing injuries and may even help contribute to saving lives in vehicle collisions. In a typical vehicle collision, there may actually be two collisions. The first collision occurs when a vehicle strikes another vehicle or object. The second collision occurs when a body of an occupant of the vehicle impacts upon one or more interior surfaces within the vehicle. It is the second collision that frequently results in the greater injuries.

Airbags help contribute to mitigating or preventing injuries by helping to prevent or alleviate the second collision. When a vehicle is equipped with one or more airbags, upon detecting the first collision, the one or more airbags are rapidly inflated to form a protective cushion between an occupant's body and an interior surface. Airbags generally are somewhat flexible to be able to absorb and distribute the energy of a bodily impact in order to help prevent more serious injuries that could result if the body impacted upon a rigid vehicle interior surface such as a dashboard, steering column, window, or another hard surface.

For an airbag to successfully help reduce the severity of or seek to prevent the second collision, the airbag should be positioned properly to help prevent the occupant's body from impacting upon one or more rigid interior surfaces. For example, referring to Prior Art FIG. 1A, a vehicle 100 involved in a collision with another object (not shown) has a vehicle interior 102 that is partially bounded at a forward end by a windshield 104. The vehicle 100 is in a frontal collision where forward momentum of the vehicle 100, represented by arrow 108, is abruptly arrested.

A body 130 of an occupant 131 is positioned in a seat 120 behind a forward structure 104 (such as a dashboard or console) within the vehicle interior 102. The body 130 is depicted as including a head 132, a torso 134, and a lower body 136. As a result of the collision, an airbag 110 is deployed from a forward structure 105 within the vehicle interior 102 to shield the body 130, thereby helping contribute to preventing the body 130 from impacting against the forward structure 105 and/or the windshield 104.

Referring to Prior Art FIG. 1B, as a result of the momentum 108 acting upon the body 130, forward momentum of the body 130, represented by arrows 140 and 142, motivates the body 130 forward from the seat 120 and into the airbag 110. The impact of the body 130 on the airbag 110 results in deformation and/or displacement of the airbag 110 from its previous configuration 110′ of FIG. 1A (represented by dashed lines in FIG. 1B). In addition, as the body 130 impacts the airbag 110, angular momentum of the body 130, as represented by arrow 144, may result in the head 132 or other parts of the body 130 further deforming or displacing the airbag 110.

Referring to Prior Art FIG. 1C, the body 130 continues to move forward after the collision. Further deformation and/or displacement of the airbag 110 resulting from forward momentum 140 and 142 and angular momentum 144 (FIG. 1B) of the body 130 may result in a further distorted configuration of the airbag 110 from its previous configuration 110″ of FIG. 1B (represented by dotted lines in FIG. 1B). As a result of the deformation and/or displacement of the airbag 110, the airbag 110 may not be able to completely fulfill its objective of preventing the body 130 from impacting upon surfaces within the vehicle interior 102. For example, as shown in FIG. 1C, the airbag 110 may be deformed and/or displaced so that the airbag 110 is not positioned to prevent the head 132 from impacting the windshield or preventing other parts of the body 130 from impacting other surfaces within the vehicle interior 102.

### SUMMARY

Disclosed embodiments include apparatuses, systems, and methods for supporting an occupant restraint airbag.

In an illustrative embodiment, an apparatus includes an occupant restraint airbag configured to be deployable between an occupant of a vehicle and a forward structure of an interior of the vehicle. The occupant restraint airbag is configured to present an occupant surface to engage at least a portion of a body of the occupant and a back surface on an opposing side of the occupant restraint airbag responsive to inflation thereof. A reaction surface airbag is configured to be deployable between the occupant restraint airbag and an interior surface of the vehicle responsive to inflation thereof. The reaction surface airbag is configured to present a first surface configured to engage the back surface of the occupant restraint airbag and a second surface configured to engage the interior surface. The reaction surface airbag is further configured to resist movement of the occupant restraint airbag toward the interior surface responsive to inflation of the reaction surface airbag.

In another illustrative embodiment, a vehicle includes a vehicle interior configured to accommodate at least one occupant. An occupant supplemental restraint system includes an occupant restraint airbag configured to be deployable between the occupant of the vehicle and a forward structure of the vehicle interior. The occupant restraint is configured to present an occupant surface to engage at least a portion of a body of the occupant and a back surface on an opposing side of the occupant restraint airbag responsive to inflation thereof. A reaction surface airbag is configured to be deployable between the occupant restraint airbag and an interior surface of the vehicle responsive to inflation thereof. The reaction surface airbag is further configured to present a first surface to engage the back surface of the occupant restraint airbag and a second surface configured to engage the interior surface. The reaction surface airbag is further configured to resist movement of the occupant restraint airbag toward the interior surface responsive to inflation of the reaction surface airbag. A triggering system is configured to sense an impact of the vehicle with another object and to initiate inflation of the occupant restraint airbag and the reaction surface airbag responsive.

In another illustrative embodiment, in an illustrative method an occupant restraint airbag is caused to be inflatably deployed between an occupant of a vehicle and a forward structure of an interior of the vehicle. The inflated occupant restraint airbag presents an occupant surface configured to engage at least a portion of a body of the occupant and a back surface on an opposing side of the occupant restraint airbag. A reaction surface airbag is caused to be inflatably deployed between the occupant restraint airbag and an interior surface. The inflated reaction surface airbag presents a first surface configured to engage the back side of the occupant restraint airbag and a second surface configured to engage the interior surface. The inflated reaction surface airbag engages the back surface of the inflated occupant restraint airbag to resist movement of the occupant restraint airbag toward the interior surface.

Further features, advantages, and areas of applicability will become apparent from the description provided herein. It will be appreciated that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, with emphasis instead being placed upon illustrating the principles of the disclosed embodiments. In the drawings:

FIGS. 1A-1C are side plan views of an interior of a vehicle showing operation of a conventional airbag;

FIG. 2 is a side plan view in partial cutaway of a vehicle equipped with a reaction surface airbag module and an occupant restraint airbag module;

FIG. 3 is a side plan view of a vehicle interior equipped with a reaction surface airbag and an occupant restraint airbag adjacent a passenger seat;

FIGS. 4-6 are side plan views of the vehicle interior of FIG. 3 showing operation of the reaction surface airbag and the occupant restraint airbag;

FIG. 7 is a side plan view of a vehicle interior equipped with a reaction surface airbag module and an occupant restraint airbag module mounted on a steering apparatus;

FIG. 8 is a side plan view of the vehicle interior of FIG. 7 showing operation of the reaction surface airbag and the occupant restraint airbag;

FIG. 9 is a side plan view of the vehicle interior of FIG. 3 in which the reaction surface airbag is adapted to deploy more rapidly than the occupant restraint airbag and/or to be more rigid than the occupant restraint airbag; and

FIG. 10 is a flow chart of an illustrative method of deploying an occupant restraint airbag and a reaction surface airbag.

### DETAILED DESCRIPTION

The following description explains, by way of illustration only and not of limitation, various embodiments of apparatuses, systems, and methods for supportably deploying an occupant restraint airbag in a vehicle. Other embodiments may be utilized, and other changes may be made, without departing from the spirit or scope of the subject matter presented here. It will be noted that the first digit of three-digit reference numbers and the first two digits of four-digit reference numbers correspond to the figure number in which the element first appears.

By way of a non-limiting introduction and overview, in various embodiments an apparatus includes an occupant restraint airbag configured to be deployable between an occupant of a vehicle and a forward structure in an interior of the vehicle. In an inflated state, the occupant restraint airbag is configured to present an occupant surface to engage a body of the occupant when the occupant restraint airbag is deployed. The occupant restraint airbag also includes a back surface on an opposing side of the occupant restraint airbag. In various embodiments, a reaction surface airbag is configured to be deployable between the occupant restraint airbag and an interior surface of the vehicle, such as a dashboard, interior surface of a windshield, or another structure. In an inflated state, the reaction surface airbag is configured to present a first surface that is configured to engage the back surface of the occupant restraint airbag and a second surface configured to engage the interior surface. Being positioned between the interior surface and the occupant restraint airbag, the reaction surface airbag is further configured to resist movement of the occupant restraint airbag toward the interior surface responsive. The reaction surface airbag thereby helps provides support to the occupant restraint airbag to help prevent deformation and/or displacement of the occupant restraint airbag that may undermine the full ability of the occupant restraint airbag to seek to contribute to helping protect the occupant's body from impacting upon interior surfaces within the vehicle.

Now that an overview has been given, details of various embodiments will be explained by way of non-limiting examples given by way of illustration only and not of limitation.

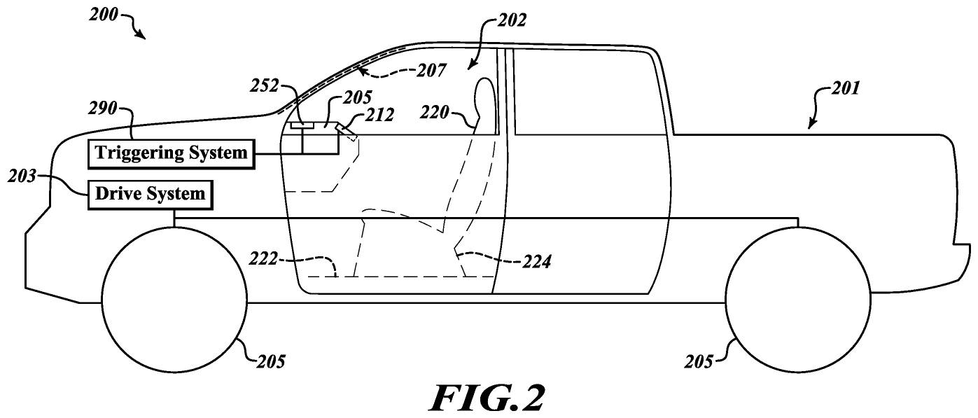

Referring to FIG. 2, in various embodiments an illustrative vehicle 200 includes a vehicle body 201, a vehicle interior 202, such as a passenger cabin, for receiving one or more occupants, and a drive system 203. In various embodiments, the drive system 203 is interoperable with wheels 205 to motivate, turn, and brake the wheels 205 to control the movement of the vehicle 200. The drive system 203 may be manually controlled by an operator (not shown in FIG. 2) within the vehicle interior 202 using control surfaces to control the speed and heading of the vehicle. The drive system 203 also may be automatically controlled by the drive system 202 and control systems associated with the drive system (not shown in FIG. 2). The drive system 203 also may be controlled by both the operator and one or more control systems providing operator assistance features, such as lane departure warnings, automatic emergency braking, and similar operator assistance features (not shown in FIG. 2) The drive system 203 may be powered by electric power, gasoline, or diesel fuel, or may include a hybrid drive system combining more than one of these technologies.

Referring additionally to FIG. 2, the vehicle interior 202 includes one or more seats 220 to receive occupants (not shown in FIG. 2). The seat 220 is secured to a floor 222 of the vehicle interior 202 by a seat mount 224. In various embodiments, the seat mount 224 may enable the seat 220 to be moved forward and backward and/or up and down for comfort of the occupant of the seat 220. The vehicle interior 202 also includes one or more interior structures. The interior structures may include a forward structure 205 disposed ahead of the seat 220, such as a dashboard or console. The interior structures also may include interior walls of a vehicle, such as an interior surface of a windshield 207.

In various embodiments, the vehicle 200 includes airbag modules, including an occupant restraint airbag module 212 and a reaction surface airbag module 252, which are shown in their undeployed, uninflated configurations. As further described below, the airbag modules 212 and 252 will be activated to deploy airbags (not shown in FIG. 2) to help contribute to protecting one or more occupants from a second collision injury that may result from the bodies of the one or more occupants impacting against the forward structure 205, the interior surface 207 of the windshield 204, or other interior structures. The operation of the airbag modules 212 and 252 are described in detail below.

The airbag modules 212 and 252 may be activated by a triggering system 290 incorporated in the vehicle 200. In various embodiments, the triggering system 290 may include a collision sensor that, for example, includes an accelerometer that is configured to detect the instantaneous deceleration of the vehicle 200 that is caused by a collision and/or other sensors that may detect a frontal impact of the vehicle 200. Upon detecting a collision, the triggering system 290 activates inflation devices (not separately shown) incorporated in the airbag modules 212 and 252. The inflation devices typically include a combustible agent that is electrically ignited upon being triggered by the inflation device. The combustion of the combustible agent rapidly fills the airbags (not shown in FIG. 2) of the airbag modules 212 and 252 with an inert gas to inflate the airbags. The chemical composition and quantity of the combustible agent may be used to control how rapidly the airbags inflate and the rigidity of the airbags in an inflated state.

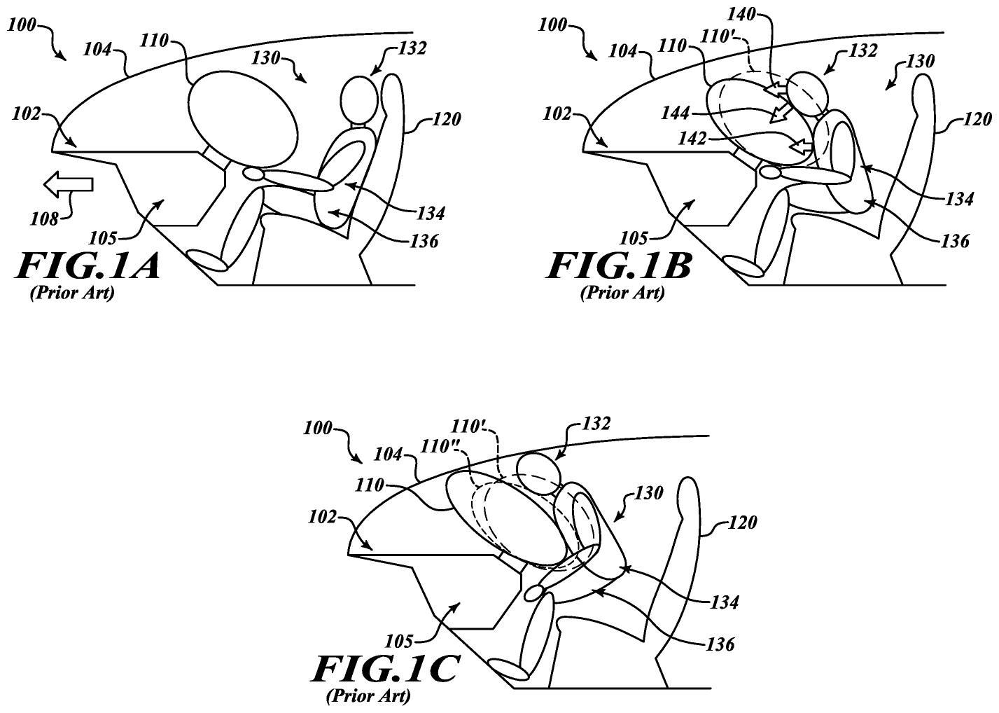

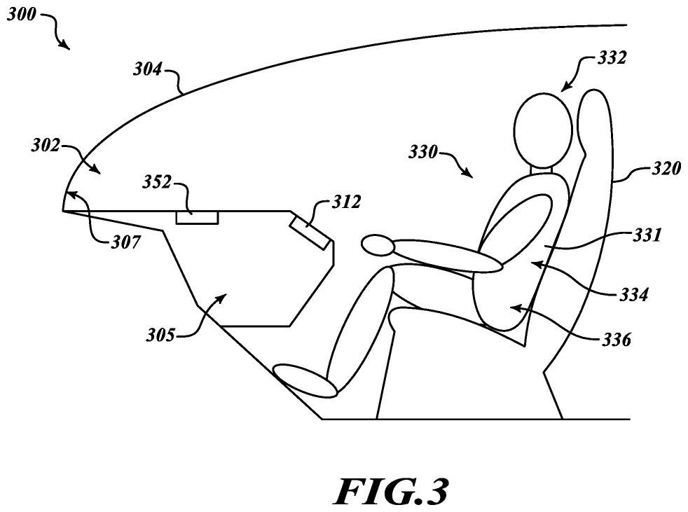

Referring to FIG. 3, a vehicle interior 302 of a vehicle 300 includes a seat 320 that receives a body 330 of an occupant 331. The body 330 includes a head 332, a torso 334, and a lower body 336, comparable to the body 130 described with reference to FIGS. 1A-1C. Although not shown in FIG. 3 or the other figures, the vehicle interior 302 also is equipped with a seatbelt and shoulder harness to restrain the body 330 of the occupant 331 in the event of a collision or an abrupt stop not involving a collision.

The vehicle interior 302 is partially bounded at a forward end by a windshield 304 having an interior surface 307. The vehicle interior 302 also includes a forward structure 305 (such as a dashboard or console) within the vehicle interior 302 positioned in front of the body 330 of the occupant 331. The forward structure 305 may support control devices for the vehicle 300 as well as comfort and convenience features such as climate controls and entertainment systems. The forward structure 305 also may present a potential impact surface that the body 330 may strike in a second collision if the vehicle 300 collides with another object.

Seeking to help mitigate or help prevent a second collision, an occupant restraint airbag module 312 and a reaction surface airbag module 352 are deployed in or on the forward structure 305. As described in detail below, in the event of a collision, the occupant restraint airbag module 312 deploys an occupant restraint airbag (not shown in FIG. 3) to present a cushion between the body 330 of the occupant 331 and the forward structure 305, the interior surface 307 of the windshield 304, and other surfaces of the vehicle interior 302.

To support the occupant restraint airbag deployed by the occupant restraint airbag module 310, the reaction surface airbag module 350 is configured to deploy a reaction surface airbag (not shown in FIG. 3) to support the occupant restraint airbag. The reaction surface airbag provides support to the occupant restraint airbag to prevent deformation and/or displacement of the occupant restraint airbag that may possibly undermine the effectiveness of the occupant restraint airbag, as further described below. In other words, the reaction surface airbag is configured to limit unwanted deformation and/or displacement of the occupant restraint airbag as a result of the body 330 of the occupant 331 impacting upon the occupant restraint airbag.

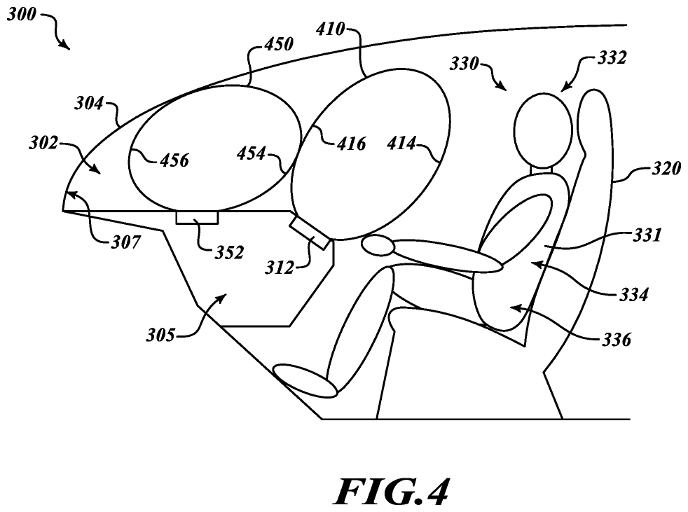

Referring to FIG. 4, as a result of an impact and in an effort to help contribute to protecting the body 330 of the occupant 331, the occupant restraint airbag module 312 deploys an occupant restraint airbag 410 and the reaction surface airbag module 352 deploys a reaction surface airbag 450. The occupant restraint airbag 410 includes one or more occupant surfaces 414 that are configured to receive the body 330 of the occupant 331. The occupant restraint airbag 410 also includes one or more back surfaces 416 on one or more other or opposing sides of the occupant restraint airbag 410. It will be appreciated that the term “back surface” is used to designate a side of the occupant restraint airbag 410 that is on an opposing side of the occupant restraint airbag 410 from the occupant restraint surfaces 414. In various embodiments, the occupant restraint airbag 410 may be deployed from a location at the rear of the vehicle 300, a side of the vehicle 300, or another part of the vehicle 300, as well as from a front of the vehicle 300 as shown in FIGS. 4-6. Accordingly, as shown in FIGS. 4-6, the back surface 416 of the occupant restraint airbag 410 may face a front of the vehicle, a side of the vehicle, or another direction relative to the direction of travel of the vehicle 300.

The reaction surface airbag 450 is deployed between the occupant restraint airbag 410 and the interior surface 307 of the windshield 304 and/or other interior surfaces of the vehicle 300. The reaction surface airbag 450 includes one or more first surfaces 454 that are configured to engage the one or more back surfaces 416 of the occupant restraint airbag 410. The reaction surface airbag 450 also includes one or more second surfaces 456 that are configured to engage the interior surface 307 of the windshield 304 and/or other interior surfaces of the vehicle interior 302. As is further described below, the reaction surface airbag 450 is configured to support the back surface 416 of the occupant restraint airbag 410 to help prevent deformation and/or displacement of the occupant restraint airbag 410.

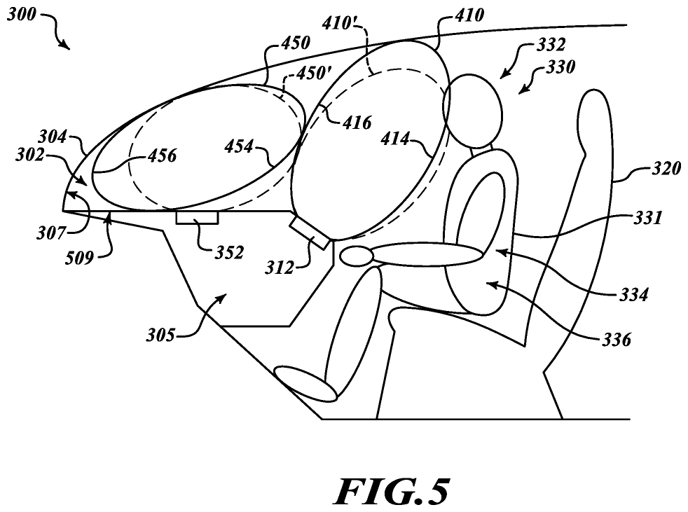

Referring to FIG. 5, as a result of the vehicle 300 becoming involved in a collision, momentum causes the body 330 of the occupant 331 to continue moving forward into the occupant restraint airbag 410. As previously described, the force of the impact of the body 330 on an airbag may deform and/or displace the airbag and, as a result, may potentially undermine the effectiveness of the airbag. For example, and as shown in FIG. 5, the impact of the body 330 on the occupant restraint airbag 410 results in the occupant restraint airbag 410 being distended and displaced toward the windshield 304 at the front of the vehicle 300. However, as compared to the example of FIGS. 1A-1C, the reaction surface airbag 450 opposes the deformation and displacement of the occupant restraint airbag 410.

The impact of the body 330 on the occupant surface 414 of the occupant restraint airbag 410 deforms and displaces the occupant restraint airbag 410 from its previous configuration 410′ of FIG. 4 (represented by dashed lines in FIG. 5) toward the windshield 304 at the front of the vehicle 300. The deformation and displacement of the occupant restraint airbag 410 cause the back surface 416 of the occupant restraint airbag 410 to abut the first surface 454 of the reaction surface airbag 450. Force imparted by the occupant restraint airbag 410 to the reaction surface airbag 450 may deform and displace the reaction surface airbag 450 toward the windshield 304 at the front of the vehicle 310.

At this point, however, the second surface 456 of the reaction surface airbag 450 abuts the interior surface 307 of the windshield 304. Additionally, other parts of the reaction surface airbag 450 may abut other interior surfaces of the vehicle 300, such as an upper surface 509 of the forward structure 305. Engagement of the second surface 456 of the reaction surface airbag 450 with interior surfaces of the vehicle 300 at least partially arrests the deformation and/or displacement of the reaction surface airbag 450. Consequently, the first surface 454 of the reaction surface airbag 450 pushes back against the back surface 416 of the occupant restraint airbag 410, thereby at least partially arresting further deformation and/or displacement of the reaction surface airbag 450. Thus, the reaction surface airbag 450 may help support the occupant control airbag 410 in a position and shape to help protect the body 330 from impacting on interior vehicle surfaces.

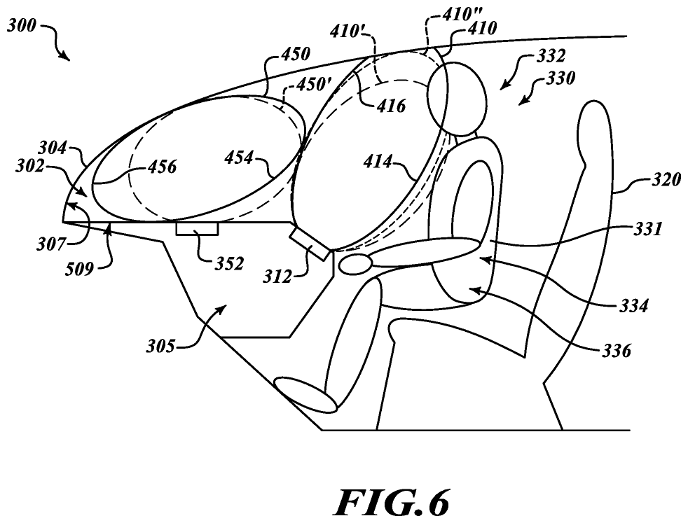

Referring to FIG. 6, as the body 330 of the occupant 331 continues to be carried by momentum into the front surface 414 of the occupant restraint airbag 410, the occupant restraint airbag 410 may be further deformed and/or displaced from its previous configuration 410″ (shown by dotted lines in FIG. 6) by the impact. However, the reaction surface airbag 450, which may be more rigid than the occupant control airbag 410, may resist any further deformation and/or displacement to the occupant control airbag 410, thereby helping the occupant restraint airbag 410 from incurring significant additional deformation and/or displacement. Thus, the reaction surface airbag 450 is configured to seek to help limit the deformation and/or displacement of the occupant restraint airbag 410.

In sum, upon occurrence of a collision, the occupant restraint airbag 410 will receive the body 330 of the occupant 331. The occupant restraint airbag 410 may be deformed and/or displaced due to the energy of the second collision of the body 330 with the occupant restraint airbag 410 being absorbed and/or dispersed. As the occupant restraint airbag 410 is deformed and/or displaced, the occupant restraint airbag 410 abuts the reaction surface airbag 450. The reaction surface airbag 450 may be deformed and/or displaced due to helping absorb and/or disperse energy of the second collision imparted by the occupant restraint airbag 410. However, the reaction surface airbag 450 may engage interior vehicle surfaces that arrest deformation and/or displacement of the reaction surface airbag 450 which, in turn, can help contribute to further resisting deformation and/or displacement of the occupant restraint airbag 410. Supporting the occupant restraint airbag thus helps prevent the occupant restraint airbag 410 from being distorted in order to protect the occupant.

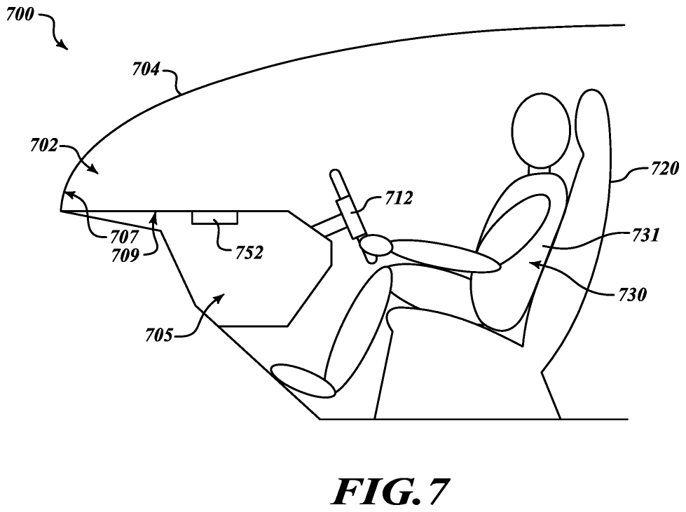

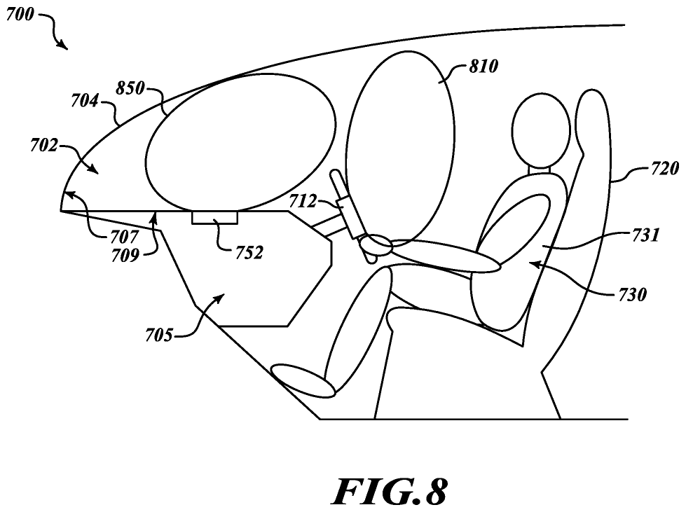

Referring to FIG. 7, it will be appreciated that one or more occupant restraint airbag modules and one or more reaction surface airbag modules also may be situated in other locations in a vehicle. In the interior 702 of a vehicle 700 of FIG. 7, an occupant restraint airbag module 712 is mounted on a steering apparatus 760, such as a steering wheel or steering column, with a reaction surface airbag module 752 mounted on another structure 705 within the vehicle 700. Referring to FIG. 8, the reaction surface airbag 850 deployed by the reaction surface airbag module 752 engages an occupant restraint airbag 810 deployed by the occupant restraint airbag module 712. As previously described with reference to FIGS. 4-6, engagement of the reaction surface airbag 850 with an interior surface 707 of a windshield 704 and/or other interior surfaces, such as an upper surface 709 of the structure 705, provides support for the occupant restraint airbag 810. Accordingly, the reaction surface airbag 850 operates to help the occupant restraint airbag 810 in seeking to protect a body 730 of an operator 731 seated in a driver's seat 720 of the vehicle.

It will be appreciated that one or more reaction surface airbags may be situated in any location where an occupant restraint airbag is used but may be positioned in a location in a vehicle's interior where there is a void into which the occupant restraint airbag may be deformed and/or displaced. For example, in a passenger van with rear bucket seats or a passenger van with multiple rows of rear seats may include an aisle or a large lateral space between adjacent seats. An occupant restraint airbag may be deployed from the back of a front seat and a reaction surface airbag may be deployed from another location on the back of the front seat, from a floorboard, or from a rear console to support the occupant restraint airbag from being deformed or displaced into the aisle or other large lateral space. In addition, in a wide vehicle, an occupant restraint airbag may be a side curtain airbag deployable from adjacent a window that is relatively far from an occupant. The reaction control airbag may be deployable from a side surface adjacent to the occupant restraint airbag to present the occupant restraint airbag from being deformed or displaced so that the occupant's body cannot slide past or around the side curtain airbag.

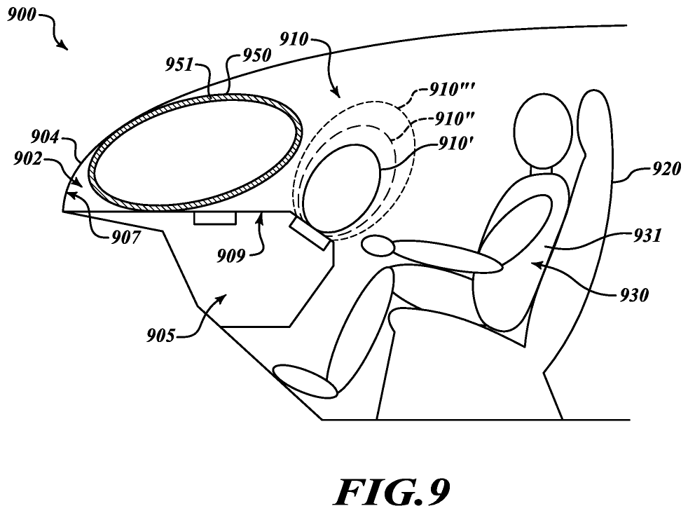

The reaction surface airbag may be configured with additional properties to help enhance its support of an occupant restraint airbag. Referring to FIG. 9, a reaction surface airbag 950 may be configured to be inflated more rapidly than an occupant restraint airbag 910. The reaction surface airbag 950 may be configured to be fully inflated while the occupant restraint airbag 910 is still being inflated. As shown in FIG. 9, as the occupant restraint airbag 910 is inflated through a series of stages 910′, 910″, and 910″' toward an eventual fully-inflated state (not shown in FIG. 9), the reaction surface airbag 950 is already inflated to its fully-inflated state. In this way, the reaction surface airbag 950 may be engaged or in position to engage interior surfaces, such as the interior surface 907 of the windshield 904 or an upper surface 900 of a structure 905, before the occupant restraint airbag 910 is inflated. The reaction surface airbag 950 thus may be positioned to prevent an unwanted degree of deformation and/or displacement of the occupant restraint airbag 910 before the occupant restraint airbag 910 is deformed upon impact by a body 930 of an occupant 931. The reaction surface airbag 950 may be more rapidly inflated, for example, by using a more rapidly combustible agent or a relatively greater quantity of combustible agent than may be used to inflate the occupant restraint airbag 910.

It also may be desirable to make the reaction surface airbag 950 more rigid and, thus, less deformable, than the occupant restraint airbag 910. It is desirable for the occupant restraint airbag 910 to be somewhat flexible to absorb and/or disperse energy from the second collision between the body 930 and the occupant restraint airbag 910. If the occupant restraint airbag 910 is very rigid, then severity of injuries to the body 930 due to impact with a very rigid occupant restraint airbag may possibly begin to approach severity of injuries to the body 930 due to impact with one of the vehicle interior surfaces. Thus, it is desirable for the occupant restraint airbag 910 to be somewhat deformable. By contrast, the reaction surface airbag 950, which generally does not come into contact with the body 930 of an occupant, may be more rigid. In various embodiments, it may be desirable for the reaction surface airbag to more rigidly support the occupant restraint airbag 910.

Referring additionally to FIG. 9, the reaction surface airbag 950 may be inflated to a greater pressure than the occupant restraint airbag 910. The reaction surface airbag 950 may be inflated to be more rigid than the occupant restraint airbag 910 by inflating it with a more highly combustible agent or a relatively greater quantity of the combustible agent to generate more pressure. The reaction surface airbag 950 may include a skin 951 capable of containing a higher gas pressure and the additional rigidity may result from the reaction surface airbag 950 being filled to a greater pressure than the occupant restraint airbag 910. In addition, the reaction surface airbag 950 may be made from a material having a more rigid skin 951 than that of the occupant restraint airbag 910.

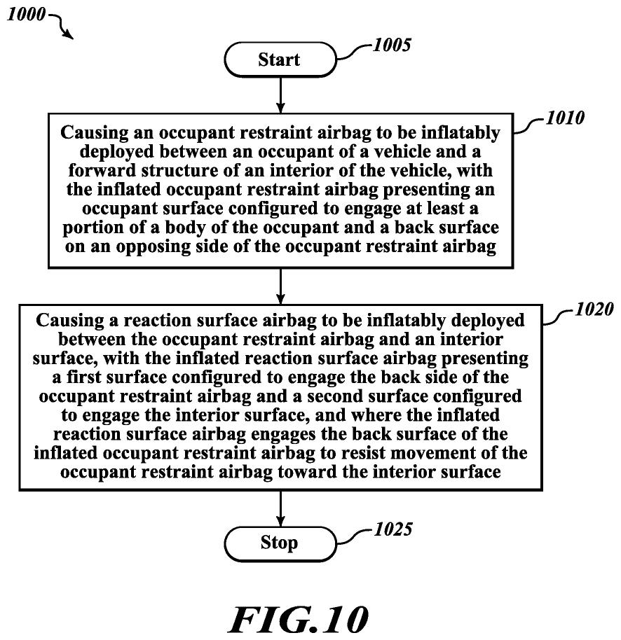

Referring to FIG. 10, in various embodiments an illustrative method 1000 is provided for using a reaction surface airbag to support an occupant restraint airbag. The method 1000 starts at a block 1005. At a block 1010, an occupant restraint airbag is caused to be inflatably deployed between an occupant of a vehicle and a forward structure of an interior of the vehicle. The inflated occupant restraint airbag presents an occupant surface configured to engage at least a portion of a body of the occupant and a back surface on an opposing side of the occupant restraint airbag. At a block 1020, a reaction surface airbag is caused to be inflatably deployed between the occupant restraint airbag and an interior surface. The inflated reaction surface airbag presents a first surface configured to engage the back side of the occupant restraint airbag and a second surface configured to engage the interior surface. The inflated reaction surface airbag engages the back surface of the inflated occupant restraint airbag to resist movement of the occupant restraint airbag toward the interior surface. These processes are described in detail with reference to FIGS. 4-6, 8, and 9. The method 1000 ends at a block 1025.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply. In addition, as used in the description herein and throughout the claims that follow, the meaning of “about” and/or “approximately” refers to ±10% of the quantity indicated, unless otherwise indicated.

It will be appreciated that the detailed description set forth above is merely illustrative in nature and variations that do not depart from the gist and/or spirit of the claimed subject matter are intended to be within the scope of the claims. Such variations are not to be regarded as a departure from the spirit and scope of the claimed subject matter.

What is claimed is:

1. An apparatus comprising:
an occupant restraint airbag configured to be deployable between an occupant of a vehicle and a forward structure of an interior of the vehicle, the occupant restraint airbag being configured to present an occupant surface to engage at least a portion of a body of the occupant and a back surface on an opposing side of the occupant restraint airbag responsive to inflation thereof; and
a reaction surface airbag configured to be deployable between the occupant restraint airbag and an interior surface of the vehicle, the reaction surface airbag being configured to present a first surface configured to engage the back surface of the occupant restraint airbag and a second surface configured to engage the interior surface responsive to inflation of the reaction surface airbag, the reaction surface airbag being further configured to resist movement of the occupant restraint airbag toward the interior surface responsive to inflation of the reaction surface airbag.

2. The apparatus of claim 1, wherein the interior surface includes at least one surface chosen from an interior wall of the interior of the vehicle and the forward structure.

3. The apparatus of claim 2, wherein the interior wall includes an inside of a windshield of the vehicle.

4. The apparatus of claim 1, wherein the forward structure includes a dashboard of the vehicle.

5. The apparatus of claim 1, wherein the reaction surface airbag is configured to be deployable from an upper surface of the forward structure.

6. The apparatus of claim 1, wherein the occupant restraint airbag is configured to be deployable from a front surface of the forward structure.

7. The apparatus of claim 1, wherein the occupant restraint airbag is configured to be deployable from a steering apparatus within the interior of the vehicle.

8. The apparatus of claim 1, wherein the reaction surface airbag is configured to inflate more quickly than the occupant restraint airbag.

9. The apparatus of claim 1, wherein the reaction surface airbag is more rigid in an inflated state than the occupant restraint airbag in an inflated state.

10. A vehicle comprising:
a vehicle interior configured to accommodate at least one occupant; and
an occupant supplemental restraint system including:
an occupant restraint airbag configured to be deployable between the occupant of the vehicle and a forward structure of the vehicle interior, the occupant restraint being configured to present an occupant surface to engage at least a portion of a body of the occupant and a back surface on an opposing side of the occupant restraint airbag responsive to inflation thereof;
a reaction surface airbag configured to be deployable between the occupant restraint airbag and an interior surface of the vehicle, the reaction surface airbag being further configured to present a first surface to engage the back surface of the occupant restraint airbag and a second surface configured to engage the interior surface responsive to inflation of the reaction surface airbag, the reaction surface airbag being further configured to resist movement of the occupant restraint airbag toward the interior surface responsive to inflation of the reaction surface airbag; and
a triggering system configured to sense an impact of the vehicle with another object and to initiate inflation of the occupant restraint airbag and the reaction surface airbag responsive to the sensed impact.

11. The vehicle of claim 10, wherein the interior surface includes at least one surface chosen from an interior wall of the vehicle and the forward structure.

12. The vehicle of claim 11, wherein the interior wall includes an inside of a windshield of the vehicle.

13. The vehicle of claim 10, wherein the forward structure includes a dashboard of the vehicle.

14. The vehicle of claim 10, wherein the reaction surface airbag is configured to be deployable from an upper surface of the forward structure.

15. The vehicle of claim 10, wherein the occupant restraint airbag is configured to be deployable from a front surface of the forward structure.

16. The vehicle of claim 10, wherein the occupant restraint airbag is configured to be deployable from a steering apparatus within the vehicle interior.

17. The vehicle of claim 10, wherein the reaction surface airbag is configured to inflate more quickly than the occupant restraint airbag.

18. The vehicle of claim 10, wherein the reaction surface airbag is more rigid in an inflated state than the occupant restraint airbag in an inflated state.

19. A method comprising:
causing an occupant restraint airbag to be inflatably deployed between an occupant of a vehicle and a forward structure of an interior of the vehicle, wherein the inflated occupant restraint airbag presents an occupant surface configured to engage at least a portion of a body of the occupant and a back surface on an opposing side of the occupant restraint airbag; and
causing a reaction surface airbag to be inflatably deployed between the occupant restraint airbag and an interior surface, wherein the inflated reaction surface airbag presents a first surface configured to engage the back side of the occupant restraint airbag and a second surface configured to engage the interior surface, and wherein the inflated reaction surface airbag engages the back surface of the inflated occupant restraint airbag to resist movement of the occupant restraint airbag toward the interior surface.

20. The method of claim 19, further comprising causing the reaction surface airbag to be inflatably deployed at least one of more quickly and more rigidly than the occupant restraint airbag.
